(19) United States
(12) Patent Application Publication
(10) Pub. No.: US 2018/0074749 A1
(43) Pub. Date: Mar. 15, 2018

(54) STORAGE DEVICE, MANAGEMENT DEVICE, STORAGE SYSTEM, DATA MIGRATION METHOD, AND COMPUTER-READABLE RECORDING MEDIUM

(71) Applicant: NEC Corporation, Minato-ku, Tokyo (JP)

(72) Inventor: Masanori KABAKURA, Tokyo (JP)

(73) Assignee: NEC Corporation, Minato-ku, Tokyo (JP)

(21) Appl. No.: 15/558,777

(22) PCT Filed: Mar. 18, 2016
(86) PCT No.: PCT/JP2016/001588

§ 371 Date: Sep. 15, 2017

(30) Foreign Application Priority Data
Mar. 20, 2015 (JP) 2015-057451

(51) Int. Cl. G06F 3/06

(52) U.S. Cl. CPC G06F 3/0647; G06F 3/0683; G06F 3/0604

(57) ABSTRACT

Provided are a storage device, a storage system, and the like which reduce, in data migration between storages, an impact on a system and the like which use data stored in the storage device.

The storage device includes: a storage unit to include a storage region which stores data, a management table storage unit to retain a management table retaining identification information relating to the storage region, access state information relating to accessibility to the storage region, and migration information indicating a state relating to migration of data stored in the storage region, and a control unit to change the access state information in accordance with a state of the data migration, based on an instruction from a management device managing migration of the data.

### TECHNICAL FIELD

The present invention relates to a storage device, a management device, a storage system, a data migration method, and a computer-readable recording medium.

### BACKGROUND ART

Data migration between storage devices may be performed along with storage device expansion, replacement, and other cases. In this case, an application that uses data stored in the storage device needs to change a storage device to be accessed in accordance with migration of the data. The change of a storage device to be accessed is preferably executed without involving stopping of the application, and occurrence of special processing on the application relevant to the change of a storage device.

PTL 1 describes a technique relating to failover and data migration. In the technique described in PTL 1, a virtual volume module in a host system provides a view of a virtual volume to user-level and system-level applications running on the host system. The virtual volume module maps input/output from the application directed to the virtual volume to a first physical volume of a first storage system. When necessary, the virtual volume module maps the input/output from the application to a second physical volume of a second storage system.

PTL 2 describes a storage system and the like. In a technique described in PTL 2, a multipath is configured over storage systems Sa and Sb in such a way that first and second storage regions are regarded as one logical storage region. Next, the storage device Sa detects start of data duplication from the first storage region to the second storage region, and controls the storage device Sb so that access to the second storage region is denied. Thereafter, the storage device Sa detects completion of data duplication from the first storage region to the second storage region, and controls the storage device Sb so that access to the first storage region is denied and access to the second storage region is permitted.

PTL 3 describes a technique such as a data migration method in a computer system that includes a storage device including a fabric connection device with a fiber channel switch. In the technique described in PTL 3, a next access path, which is to be set instead of a specific access path in an available state among access paths, is set between a host computer and a migration-destination logical unit via a host port and a migration-destination port. Thereafter, the next access path is set to an available state, and the state of the specific access path is set to an unavailable state. After the next access path is set to an available state, data are migrated from a migration-source logical unit of a migration-source storage device to the migration-destination logical unit of a migration-destination storage device.

### CITATION LIST

### Patent Literature

[PTL 1] Japanese Unexamined Patent Application Publication No. 2006-048676

[PTL 2] Japanese Unexamined Patent Application Publication No. 2011-192269

[PTL 3] Japanese Translation of PCT International Application Publication No. 2014-519061

### SUMMARY OF INVENTION

### Technical Problem

In the technique described in each of PTLs, a system and the like which use data stored in a storage device being a migration target, when accessing the data in data migration between storages, may require monitoring relating to a migration status and the like of data. In other words, in the technique described in each of PTLs, it may be difficult to migrate data between storages without causing an impact on a system and the like which use data stored in a storage device being a migration target.

The present invention has been made in order to solve the problem described above, and a main object of the present invention is to provide a storage device and the like which reduce an impact on a system or other devices which use data stored in the storage device in case of data migration between storage devices.

### Solution to Problem

A storage device according to one aspect of the present invention includes: storage means for including a storage region which stores data, management table storage means for retaining a management table retaining identification information relating to the storage region, access state information relating to accessibility to the storage region, and migration information indicating a state relating to migration of data stored in the storage region, and control means for changing the access state information in accordance with a state of the data migration, based on an instruction from a management device managing migration of the data.

A data migration method according to one aspect of the present invention includes: retaining a management table which retains identification information relating to a storage region, access state information relating to accessibility to the storage region, and migration information indicating a state relating to migration of data stored in the storage region, migrating data stored in the storage region, changing the access state information in accordance with a state of migration of the data.

A computer-readable recording medium according to one aspect of the present invention non-transitorily stores a program causing a computer to execute: retaining a management table which retains identification information relating to a storage region, access state information relating to accessibility to the storage region, and migration information indicating a state relating to migration of data stored in the storage region, migrating data stored in the storage region, and changing the access state information in accordance with a state of the data migration.

In addition, a storage system according to one aspect of the present invention includes: a migration-source storage device and a migration-destination storage device each of which is the above-described storage device, and a management device which manages the data migration from the migration-source storage device to the migration-destination storage device, wherein the management device includes: data migration table storage means for storing a data migration table which retains information relating to the storage region in each of the migration-source storage device and the migration-destination storage device and a state of the data migration, and management control means for controlling the data migration and change of the access state information in each of the migration-source storage device and the migration-destination storage device in accordance with the data migration.

### Advantageous Effects of Invention

The present invention is able to provide a storage device and the like which reduce an impact on a system which uses data stored in the storage device in case of data migration between storage devices.

### BRIEF DESCRIPTION OF DRAWINGS

FIG. 1 is a diagram illustrating a configuration of a storage device according to a first example embodiment of the present invention.

FIG. 2 is a diagram illustrating a configuration of a storage system according to the first example embodiment of the present invention.

FIG. 3 is a diagram illustrating an example of a management table used in the storage device according to the first example embodiment of the present invention.

FIG. 4 is a diagram illustrating an example of a data migration table used in the storage system according to the first example embodiment of the present invention.

FIG. 5 is a diagram illustrating an example of a path management table according to the first example embodiment of the present invention.

FIG. 6 is a diagram illustrating an operation example of data migration performed by a storage system 10 according to the first example embodiment of the present invention.

FIG. 7 is a diagram illustrating another operation example of data migration performed by the storage system 10 according to the first example embodiment of the present invention.

FIG. 8 is a diagram illustrating another operation example of data migration performed by the storage system 10 according to the first example embodiment of the present invention.

FIG. 9 is a diagram illustrating another operation example of data migration performed by the storage system 10 according to the first example embodiment of the present invention.

FIG. 10 is a diagram illustrating another operation example of data migration performed by the storage system 10 according to the first example embodiment of the present invention.

FIG. 11 is a diagram illustrating another operation example of data migration performed by the storage system 10 according to the first example embodiment of the present invention.

FIG. 12 is a flowchart illustrating an operation example performed by the storage system 10 according to the first example embodiment of the present invention.

FIG. 13 is a diagram illustrating a configuration example of an information processing device which implements each device according to the example embodiment of the present invention.

### DESCRIPTION OF EMBODIMENTS

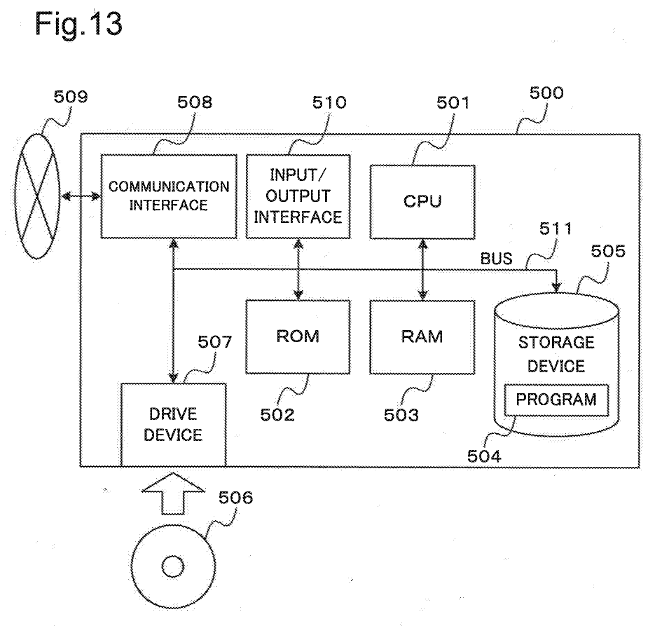

Example embodiments of the present invention will be described with reference to the accompanying drawings. Note that, in the example embodiments of the present invention, components in each device indicate blocks on a function basis. Components in each device can be implemented by, for example, suitably-selected combinations of an information processing device 500 as illustrated in FIG. 13 and software. As an example, the information processing device 500 includes configurations as follows.

—a CPU (Central Processing Unit) 501

—a ROM (Read Only Memory) 502

—a RAM (Ramdom Access Memory) 503

—a program 504 to be loaded on the RAM 503

—a storage device 505 storing the program 504

—a drive device 507 for reading and writing a recording medium 506

—a communication interface 508 connected with a network 509

—an input/output interface 510 for inputting and outputting data

—a bus 511 connecting the respective components

Components in each device according to each of the example embodiments are implemented by the CPU 501 acquiring and executing the program 504 which implements these functions. The program 504 implementing the functions of the components in each device is stored in, for example, the storage device 505 and the RAM 503 in advance, and is read out by the CPU 501 as needed. Note that the program 504 may be supplied to the CPU 501 via the communication network 509, or the program stored in the recording medium 506 in advance may be read out and supplied to the CPU 501 by the drive device 507.

There are various modification examples of a method of implementing each device. For example, each device may be implemented by suitably-selected combination of the information processing device 500 and a program which are respectively different for each component. In addition, a plurality of components included in each device may be implemented by suitably-selected combinations of one information processing device 500 and a program.

In addition, part or all of components in each device are implemented by a general-purpose or dedicated circuitry, a processor, and other devices, or a combination thereof. These may be configured by a single chip, or may be configured by a plurality of chips connected through a bus. Part or all of components in each device may be implemented by a combination of the above-described circuitry or the like and a program.

When part or all of components in each device are implemented by a plurality of information processing devices, circuitries, and the like, the plurality of information processing devices, the circuitries, and the like may be centralizedly arranged, or may be dispersedly arranged. For example, information processing devices, circuitries, and the like may be implemented as a mode, such as a client and server system, and a cloud computing system, in which the information processing devices, the circuitries, and the like are respectively connected via a communication network. Note that, in the example embodiments of the present invention, “data migration” indicates moving information recorded to a storage device storing data or on an arbitrary storage region configured in the storage device to another storage device or other devices. When data migration is carried out, recording and reading of data to a storage device that is a migration source or the like is switched so that the recording and reading is performed on a storage device that is a migration destination or the like. Data migration is performed along with, for example, storage device expansion or replacement.

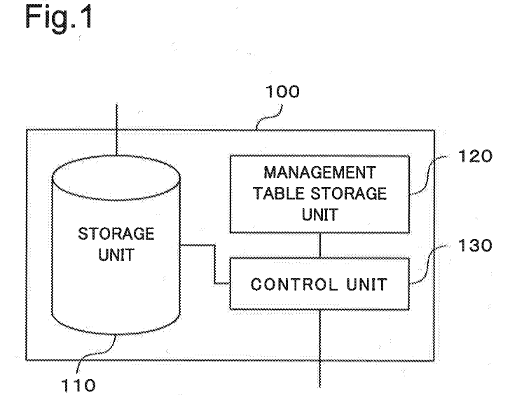

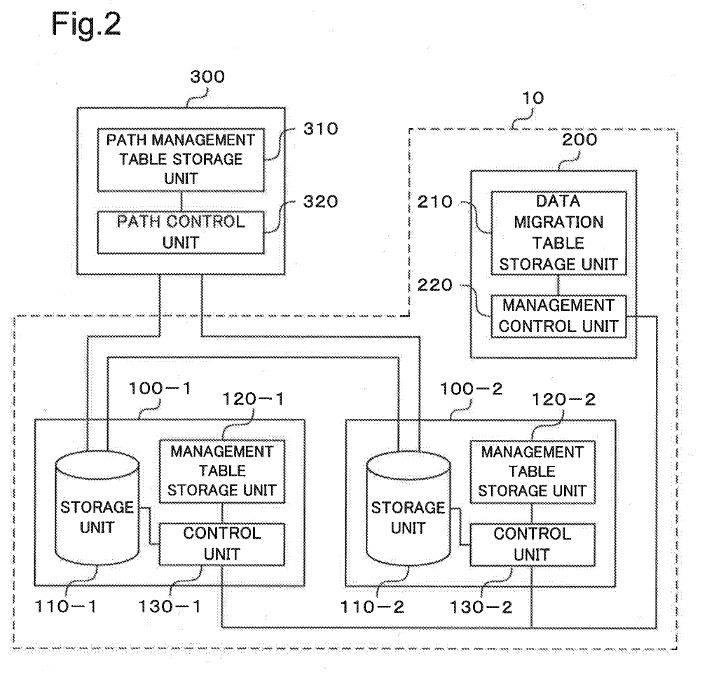

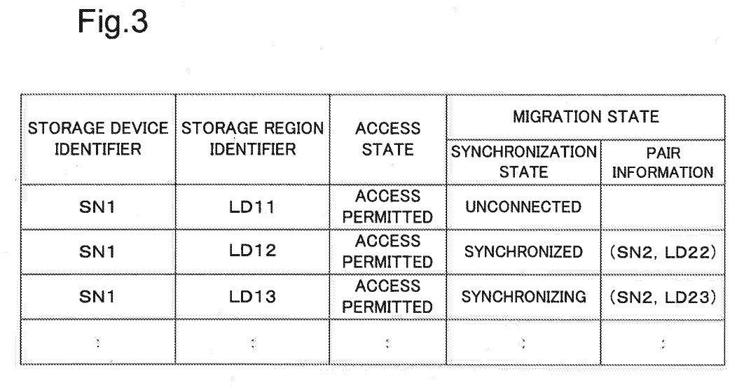

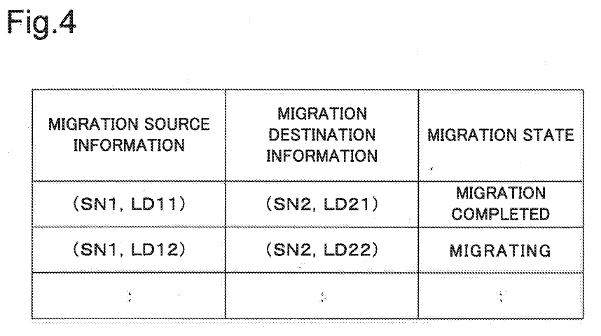

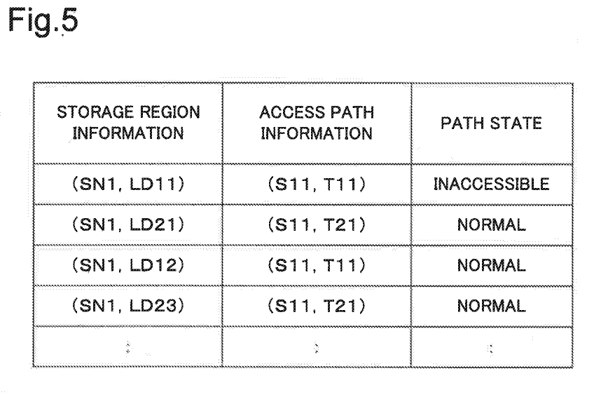

First, a first example embodiment of the present invention will be described. FIG. 1 is a diagram illustrating a configuration of a storage device 100 according to the first example embodiment of the present invention. FIG. 2 is a diagram illustrating a configuration of a storage system 10 according to the first example embodiment of the present invention. FIG. 3 is a diagram illustrating an example of a management table used in the storage device according to the first example embodiment of the present invention. FIG. 4 is a diagram illustrating an example of a data migration table used in the storage system according to the first example embodiment of the present invention. FIG. 5 is a diagram illustrating an example of a path management table according to the first example embodiment of the present invention.

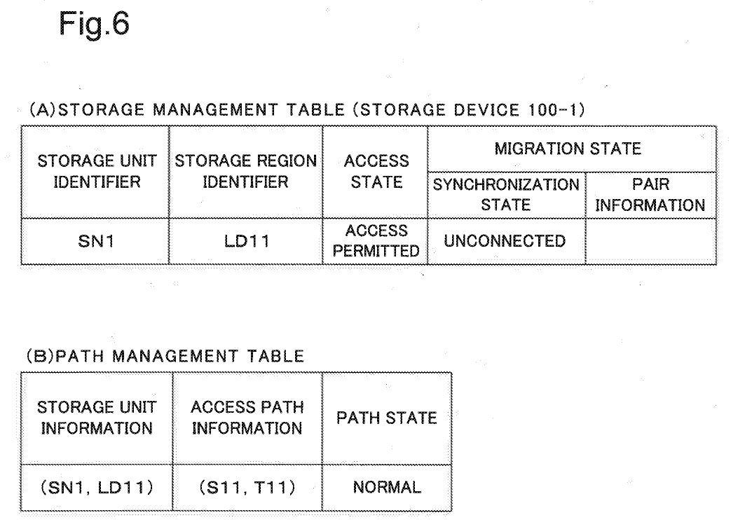

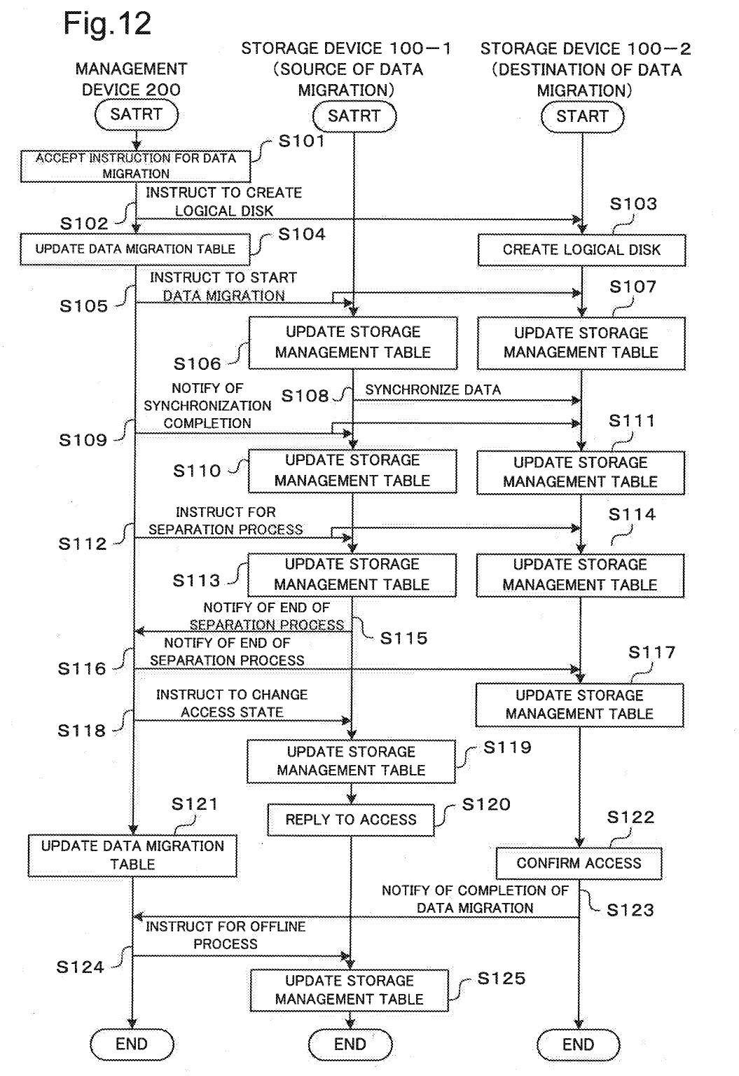

Each figure of FIGS. 6 to 11 is a diagram illustrating an operation example of data migration in the storage system 10 according to the first example embodiment of the present invention. FIG. 12 is a flowchart illustrating an operation example of the storage system 10 according to the first example embodiment of the present invention. FIG. 13 is a diagram illustrating a configuration example of an information processing device that implements each device according to the example embodiment of the present invention.

As illustrated in FIG. 1, the storage device 100 according to the first example embodiment of the present invention includes a storage unit 110, a management table storage unit 120, and a control unit 130. The storage unit 110 includes, for example, a storage region to be described later, and stores data. The management table storage unit 120 retains a management table to be described later. The control unit 130 controls data migration, and changes access state information or other information included in the management table in accordance with a state of the data migration. In addition, the control unit 130 creates a storage region of the storage unit 110, records data to the storage region, or reads out data from the storage region.

Further, as illustrated in FIG. 2, the storage system 10 according to the first example embodiment of the present invention includes storage devices 100-1 and 100-2, and a management device 200. Each of the storage devices 100-1 and 100-2 is the above-described storage device 100. In the storage system 10 according to the present example embodiment, the storage device 100-1 operates as a migration-source storage device being a source of data migration. Likewise, the storage device 100-2 operates as a migration-destination storage device being a destination of data migration.

In the storage system 10 according to the present example embodiment, the storage devices 100-1 and 100-2 are connected with each other in a mode capable of transmitting and receiving data via an access path for exchanging data. The access path is implemented by using appropriately-selected connection interface.

The management device 200 includes a data migration table storage unit 210 and a management control unit 220. The data migration table storage unit 210 retains a data migration table to be described later. The management control unit 220 manages data migration to the storage devices 100-1 and 100-2. For example, the management control unit 220 controls data migration from the storage device 100-1 to the storage device 100-2. In addition, the management control unit 220 controls, in accordance with a state of the data migration, change of an accessibility status to each of storage regions of storage units 110-1 and 110-2 included in the storage devices 100-1 and 100-2, and the like. The management device 200 is communicably connected to the storage devices 100-1 and 100-2 via a communication network and the like. Access to a storage region of the storage unit 110 represents recording and reading of data, or requesting for recording and reading of data in the recording region or to the recording region.

In addition, the storage devices 100-1 and 100-2 in the storage system 10 according to the present example embodiment are connected to an operation server 300 in a mode capable of recording and reading data via an access path. The access path is implemented by using an appropriately-selected connection interface. In the operation server 300, various types of software or the like are executed by using data stored in the storage system 10.

The operation server 300 includes a path management table storage unit 310 and a path control unit 320, in order to allow recording and reading of data with the storage system 10. The path management table 310 stores a path management table to be described later. The path control unit 320 determines a storage device 100 to be accessed among storage devices 100 included in the storage system 10, based on information retained in the path management table.

Next, components of the storage device 100 and the storage system 10 according to the present example embodiment will be described.

In the storage device 100, the storage unit 110 stores data, as described above. The storage unit 110 is implemented by, for example, a suitable-selected number of disk drives. A Hard Disk Drive (HDD) and a Solid State Drive (SSD) can be used as the disk drive.

In the storage unit 110, for example, a storage region having a freely-selected capacity and being treated as one integrated region may be configured. This storage region is a region being treated logically as one region, for example, regardless of the number and configurations of disk drives implementing the storage region. In addition, the storage unit 110 may include an arbitrary number of storage regions. In each of the storage regions, storage regions may further be configured in a hierarchical manner. Data migration is performed by using, for example, this storage region as a unit.

The management table storage unit 120 stores a management table. The management table retains access state information, migration information and other information. The access state information is information indicating a state relating to accessibility to a storage region or the like included in the storage unit 110. The migration information is information indicating a state relating to data migration between the storage unit 110 and a suitably-selected storage unit included in another device. When an arbitrary number of storage regions are configured in the storage unit 110, these pieces of information may be generated for each of the storage regions and retained in the management table.

A configuration example of a management table stored in the management table storage unit 120 will be descried by using FIG. 3. In an example of a management table illustrated in FIG. 3, information relating to a storage device identifier, a storage region identifier, an access state, and a migration state is retained in the management table. The information relating to a migration state includes synchronization state information and pair information. Note that, in the example illustrated in FIG. 3, a case such that a plurality of storage regions can be configured in the storage unit 110 included in the storage device 100 is assumed.

The “storage device identifier” indicates information such as access state information, migration information and the like stored in a management table, which identifies the storage device 100 to be a target . As the information identifying the storage device 100, for example, an identifier determined for each of the storage devices 100 in any format is used. In the example illustrated in FIG. 3, a storage device identifier “SN1” is assigned to the storage device 100 and retained.

The “storage region identifier” indicates information such as access state information, migration information, and the like stored in a management table, which specifies a storage region and the like to be a target. In this item, a storage region configured in the storage device 100 specified in an item relating to the storage device identifier described above is specified. As the information specifying a storage region and the like, an identifier determined for a storage region in any format is used. In the example illustrated in FIG. 3, storage region identifiers “LD11”, “LD12”, and “LD13” are designated, and information relating to storage regions is retained.

The “access state” is an item indicating the access state information described above. In the present example embodiment, for the item of the access state information, it is assumed that four pieces of information “access permitted”, “access denied”, “separation completion waiting”, and “offline” are retained as information indicating a state with respect to accessibility.

“Access permitted” indicates a state in which access of data from an external device and the like including the operation server 300 to a storage region designated in the storage device identifier and the storage region identifier is permitted.

“Access denied” indicates a state in which access of data from an external device and the like including the operation server 300 to the storage region described above is denied. In this case, when access to data in the storage region is requested, the storage device 100 returns a response of denying the access.

“Separation complete waiting” indicates a state in which the storage region described above becomes a target of data migration and a process relevant to completion of data migration is carried out on the storage region. In this case, when access to data in the storage region is requested, the storage device 100 returns a response indicating that a change has occurred in an access state.

“Offline” indicates a state in which the storage region described above is logically disconnected from an external device and the like including the operation server 300. In this case, the storage region is not recognized from the external device and the like including the operation server 300.

In the example illustrated in FIG. 3, “access permitted” is designated as an access state for all of storage regions having storage region identifiers designated as “LD11”, “LD12”, and “LD13”.

The “migration state” is an item which indicates the migration state described above. In the example illustrated in FIG. 3, migration information includes information which indicates a state relating to a synchronization state, and pair information which is information indicating a counterpart of data migration.

In the present example embodiment, the information relating to a synchronization state retains information indicating progress of data migration. In the example illustrated in FIG. 3, it is assumed that the information relating to a synchronization state retains information relating to four states “unconnected” “synchronizing” “synchronized”, and “separating”.

“Unconnected” indicates a state in which a process relating to data migration is not performed regarding a storage region of the storage device 100 designated in the storage device identifier and the storage region identifier. “Synchronizing” indicates a state in which a synchronization process (to be described later) of data associated with data migration is performed between the storage region and another storage region. “Synchronized” indicates a state in which a synchronization process of data according to data migration is completed between the storage region and another storage region. “Separating” indicates a state in which a synchronization process of data associated with data migration is completed between the storage region and another storage region and the synchronization process is being cleared.

In addition, in the present example embodiment, the pair information includes information on a storage device, a storage region, and the like being a counterpart with which data migration is performed. In the example illustrated in FIG. 3, a pair of information relating to a storage device identifier and a storage region identifier is designated as the pair information.

In the example illustrated in FIG. 3, information “unconnected” is designated as a synchronization state for a storage region having a storage region identifier designated as “LD11”. Since this case is a state in which a process relating to data migration is not carried out, pair information is not designated.

Further, information “synchronized” is designated as a synchronization state for a storage region having a storage region identifier designated as “LD12”. In addition, a pair of information (SN2, LD22) relating to a storage device identifier and a storage region identifier (hereinafter referred to as a “pair of identifiers”) is designated in the pair information, as a destination of data migration. This pair of identifiers indicates a storage region with a storage region identifier designated as “LD22”, which is configured in the storage device 100 having a storage device identifier designated as “SN2”. Likewise, for a storage region having a storage region identifier designated as “LD13” information “synchronizing” is designated as a synchronization state, and a pair of identifiers (SN2, LD23) is designated in the pair information.

The control unit 130 controls data migration of a designated storage region and the like, based on an instruction and the like from the management device 200. In addition, the control unit 130 changes access state information included in the management table described above, along with this data migration.

In this case, the control unit 130 changes access state information, in such a way as to change a state of accessibility from the operation server 300 to a storage region and the like of the storage unit 110 to be a migration target of data, in accordance with a state of data migration. In other words, the control unit 130 changes access state information to any of “access permitted”, “separation completion waiting” or “access denied” as appropriate, in accordance with progress or other status of data migration.

The control relating to accessibility to a storage region and the like performed by the control unit 130 enables, for example, the operation server 300 to switch an access destination of data without periodical monitoring in data migration of a storage device.

Next, components of the management device 200, that is a component of the storage system 10, will be described.

The data migration table storage unit 210 stores a data migration table. The data migration table retains information relating to correspondence between the storage device 100-1 to be a source of data migration and the storage device 100-2 to be a destination of data migration.

A configuration example of a data migration table will be described by using FIG. 4. In an example of a data migration table illustrated in FIG. 4, migration source information, migration destination information, and information relating to a migration state are retained. In other words, the data migration table retains information relating to a storage device to be a target of data migration and a state of the data migration.

The “migration source information” indicates information relating to a storage region and other information of the storage device 100, which is to be a source of data migration. In the example illustrated in FIG. 4, the information relating to the storage region as described above is represented by using a pair of identifiers described in the example of the management table illustrated in FIG. 3.

The “migration destination information” indicates information which relates to a storage region and other information of the storage device 100, which is to be a destination of data migration. In the example illustrated in FIG. 4, the information relating to the storage region as described above is represented by using a pair of identifiers, similarly to the “migration source information”.

The “migration state” indicates information relating to a status of data migration from a storage region and other region indicated by the migration source information to a storage region and other region indicated by the migration destination information. In the example illustrated in FIG. 4, it is assumed that the data migration table retains information of either “migrating” or “migration completed” as a migration state. In this example, “migrating” indicates that data migration is being performed. In addition, “migration completed” indicates that a process of data migration, which also includes a process of changing an access state, is completed.

In an example of a management table illustrated in FIG. 4, two pieces of information are retained. One piece of information indicates that data migration from a storage region represented as a pair of identifiers (SN1, LD11) to a storage region represented as a pair of identifiers (SN2, LD21) is completed. Another piece of information indicates that data migration from a storage region represented as a pair of identifiers (SN1, LD12) to a storage region represented as a pair of identifiers (SN2, LD22) is being performed.

The management control unit 220 controls start of data migration for migration-source and migration-destination storage devices, change of a state of accessibility to each of storage units included in the migration-source and migration-destination storage devices in accordance with the data migration, and the like.

A path management table stored in the path management table 310 of the operation server 300, which is connected with the storage device 100 and the storage system 10, will be described in conjunction with the storage device 100 and the storage system 10. FIG. 5 is an example of a path management table. In the example of the path management table illustrated in FIG. 5, storage region information, access path information, and information relating to a path state are retained in the path management table. As descried previously, the path control unit 320 included in the operation server 300 determines, based on information retained in this path management table, the storage device 100 to be accessed when recording and reading data.

The “storage region information” indicates information on a storage device to be accessed by the operation server 300 and a storage region configured in a storage device and the like. In the example illustrated in FIG. 5, the storage region information is represented by the pair of identifiers which is described above.

The “access path information” is information which indicates a path of access to the storage device 100 to be a target of access from the operation server 300 and a storage region and the like thereof.

In the example illustrated in FIG. 5, the access path information uses a pair of identifiers each of which distinguishes a port (not illustrated) for transmitting and receiving data included in the operation server 300, the storage devices 100-1 and 100-2, or the like. In other words, it is indicated that data are recorded and read, to and from a storage region having a pair of identifiers (SN1, LD11), via a path from a port S11 of the operation server 300 to a port T11 of a storage device.

The “path state” is information that indicates a state relating to whether data can be recorded to or read from a storage region and the like specified in the storage region information described above, via a path specified in the access path information. In the present example embodiment, as the item of path route, it is assumed that information relating to three states of “normal”, “inaccessible”, and “separation completion waiting” is retained.

“Normal” indicates a state in which it is possible to record data to and read data from a storage region and the like specified by information indicated in the storage region information, via a path specified in the access path information.

“Inaccessible” indicates a state in which it is possible to record data to and read data from a storage region and the like specified by information indicated in the storage region information, via a path specified in the access path information.

“Separation complete waiting” indicates a state in which a process associated with completion of data migration is being performed in a storage region and the like specified by information indicated in the storage region information, and recording data to and reading data from the storage region and the like is suspended.

Note that, when the access path information retains information indicating a plurality of paths to an identical storage region and the like, the operation server 300 may select one of the plurality of paths and access to the storage region and the like. This achieves distribution of a load on the storage system 10 and other devices.

Next, an operation of data migration in the storage device 100 and the storage system 10 according to the first example embodiment of the present invention will be described by using figures in FIGS. 6 to 11 and a flowchart illustrated in FIG. 12.

In this example, a case is assumed in which data migration from the storage device 100-1 to the storage device 100-2 is performed in the storage system 10 illustrated in FIG. 2. In addition, the storage device 100-1 is assigned with a storage device identifier “SN1”. The storage unit 110-1 included in the storage device 100-1 includes a storage region having a storage region identifier “LD11”. Likewise, the storage device 100-2 is assigned with a storage device identifier “SN2”. Moreover, the storage unit 110-2 included in the storage device 100-2 includes a storage region having a storage region identifier “LD12”.

Note that, in this example, it is assumed that the storage region with the storage region identifier “LD11” described above is created in the storage unit 110-1 included in the storage device 100-1 at a start of data migration. In addition, it is assumed that a storage region is not created in the storage unit 110-2 included in the storage device 100-2.

FIG. 6(A) illustrates an example of a management table retained in a management table storage unit 120-1 included in the storage device 100-1, at a start of data migration. In the management table illustrated in FIG. 6(A), an access state to a storage region with a storage device identifier “SN1” and a storage region identifier “LD11” is “access permitted”. In other words, recording data to and reading data from the storage region is possible. In addition, as state information, a synchronization state is “unconnected”. In other words, data migration to this storage region is not performed in this state. In addition, since data migration is not performed, pair information is blank.

FIG. 6(B) is a diagram illustrating an example of a path management table retained in the path management table 320 of the operation server 300 which accesses the storage system 10, at a start of data migration. According to FIG. 6(B), with respect to a storage region having a pair of identifiers (SN1, LD11), it is indicated that access is possible via a path from a port S11 of the operation server 300 to a port T11 of a storage device.

In this example, first, the management control unit 220 of the management device 200 receives an instruction for data migration (Step S101). As an example of the instruction for data migration, the management control unit 220 receives information relating to a storage device identifier and a storage region identifier of a storage device to be a migration source, as well as information relating to a storage device identifier of a storage device to be a migration destination.

In this data migration example, information that a storage device identifier is “SN1” and a storage region identifier is “LD11” is given to the management control unit 220, as information relating to the storage device 100-1 to be a migration source. In addition, a storage device identifier “SN2” is given to the management control unit 220, as information relating to the storage device 100-2 to be a migration destination. Data migration is instructed through any suitable input means included in the management device 200, and a communication network (both not illustrated), for example.

Next, the management control unit 220 of the management device 200 instructs, as needed, the storage device 100-2 to be a migration destination to create a storage region (Step S102). Upon receiving the instruction from the management device 200, the storage device 100-2 creates a migration-destination storage region (Step S103).

In this case, a control unit 130-2 included in the storage device 100-2 creates a storage region having a storage device identifier “SN1” and a storage region identifier “LD11” in the storage unit 110-2. In other words, the same identifiers as a storage device identifier and a storage region identifier assigned with a storage region to be a migration source are assigned for a newly created storage region. This enables the path control unit 320 of the operation server 300 to recognize the migration-destination storage region created in the storage device 100-2 as being the logically same region as the migration-source storage region present in the storage device 100-1. In addition, “access denied” is set as an access state with respect to the storage region, and “unconnected” is set in the synchronization state as a migration state. The pair information relating to the storage region is blank. These pieces of information are retained in a management table storage unit 120-2 as appropriate.

Note that, in a case in which the above-described storage region is newly created, the storage region is recognized by, for example, the operation server 300. In this case, the path control unit 320 included in the operation server 300 acquires information on the storage region created in the storage device 100-2 via an access path. The acquired information is retained, as path management information, in the path management table storage unit 310.

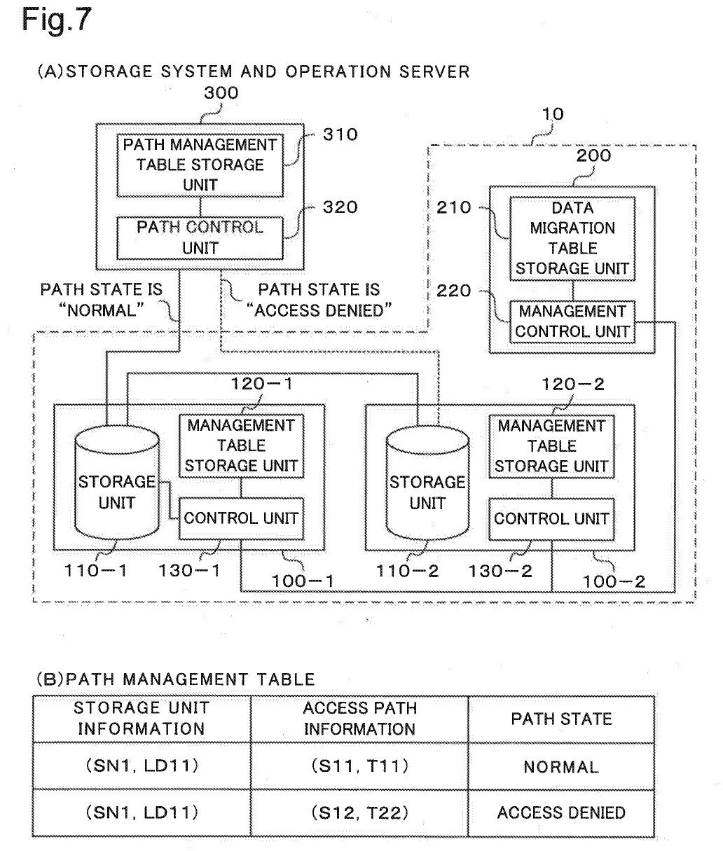

In an example illustrated in FIG. 6, the path control unit 320 acquires information indicating a pair of identifiers (ST1, LD11) as storage unit information, and information indicating a path from a port S12 of the operation server 300 to a port T22 of a storage device as access path information. In addition, for this path, the path control unit 320 acquires information indicating a path state “access denied”. In this case, the path management table storage unit 310 retains a path management table illustrated in FIG. 7(B).

Note that the path management table illustrated in FIG. 7(B) retains pieces of information relating to a plurality of paths having the same pair of identifiers designated as storage unit information. These pieces of information relating to paths correspond to the storage devices 100-1 and 100-2 respectively, in order from top in the figure. The path control unit 320 then determines an access destination based on the path information in the path management table. As illustrated in FIG. 7(A), in this case, a state of path from the operation server 300 to the storage device 100-1 is “normal”, and a state of path from the operation server 300 to the storage device 100-1 is “access denied”. Thus, the path control unit 320 controls in such a way that the operation server 300 accesses the storage device 100-1 via a path from a port S11 of the operation server 300 to a port T11 of a storage device.

Next, a process of data migration is performed. The management control unit 220 included in the management device 200 updates a data migration table (Step S104). Specifically, the management control unit 220 adds information relating to the storage region, which is created beforehand in the storage device 100-2 at Step S 103, to a data migration table, and stores the data migration table in the data migration table storage unit 210.

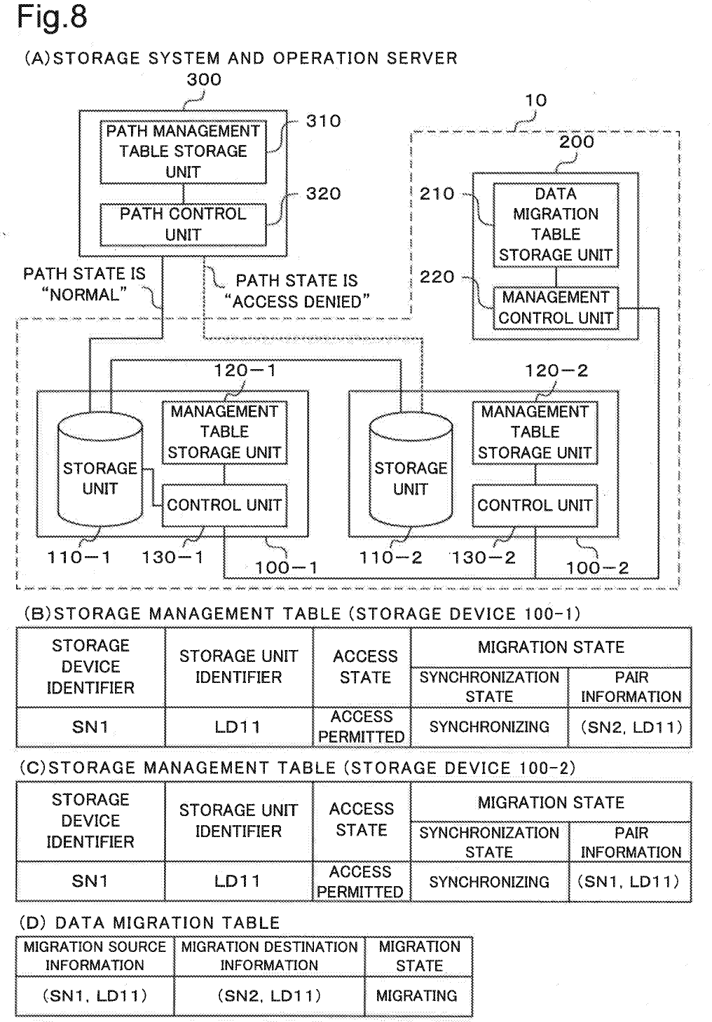

In this example, the management control unit 220 adds a pair of identifiers in which migration source information is (SN1, LD11) and migration destination information is (SN2, LD11) to a data migration table. In addition, it is assumed that a migration state for this information is “migrating”. FIG. 8(D) illustrates an example of a data migration table in this case.

Note that, in this case, the management control unit 220 sets “SN2” to a storage device identifier for the storage device 100-2. In other words, the management control unit 220 assigns the storage device 100-2 with a storage device identifier different from the storage device identifier for the storage device 100-1. In this way, the management control unit 220 of the management device 200 makes migration-source and migration-destination storage regions to be distinguishable.

Next, as one process of data migration, the storage system 10 performs a data synchronization process through processing from Steps S105 to S109. As a data migration process, the management control unit 220 included in the management device 20 instructs the storage devices 100-1 and 100-2 to start data migration (Step S105).

Each of the storage devices 100-1 and 100-2 updates a storage management table, when receiving the instruction for starting data migration (Steps S106 and S107). Each of the storage devices 100-1 and 100-2 updates information relating to a migration state in a storage management table. The updated management table is as in examples illustrated in FIGS. 8(B) and 8(C).

The storage device 100-1 sets “synchronizing” to information relating to a synchronization state in the migration state. In addition, the storage device 100-1 sets a pair of identifiers (SN2, LD11) to pair information included in the migration state. In other words, the storage device 100-1 uses, as a storage management identifier for the storage device 100-2, the storage management identifier assigned by the management device 200.

The storage device 100-2 sets “synchronizing” to information relating to a synchronization state in the migration state. In addition, the storage device 100-2 sets a pair of identifiers (SN1, LD11) to pair information included in the migration state.

Note that the processing of Steps S106 and S107 is performed in freely-selected order.

Next, a data synchronization process from the storage region formed in the storage device 100-1 being a migration source to the storage region formed in the storage device 100-2 is performed. The data synchronization process is achieved by using a publicly known technique.

As an example, the data synchronization process includes two processes: an initial synchronization process and a differential synchronization process. In the initial synchronization process, a control unit 130-1 included in the storage device 100-1 transfers data stored in the storage region of the storage unit 110-1, which is a migration source, to the storage region created in the storage unit 110-2 of the storage device 100-2, which is a migration destination.

Specifically, the control unit 130-1 sequentially transfers data stored in the storage region of the storage unit 110-1 to be a migration source, for example, from an initial address to a last address via an access path. The control unit 130-2 included in the storage device 100-2 records the transferred data to the storage region of the storage unit 110-2 to be a migration destination.

During the initial synchronization process, the storage system 10 may be requested for writing and reading of data from outside of the storage system 10, such as the operation server 300.

When receiving a request for writing to data stored in a region where transfer of data is not completed in the storage region of the storage unit 110-1 being a migration source, the control unit 130-1 writes data requested for writing to the storage region. When receiving a request for writing to data stored in a region where transfer of data is completed in the storage region of the storage unit 110-1, the control unit 130-1 writes data requested for writing to the storage region. Then, the control unit 130-1 retains, as differential information, a written address and data. The differential information is retained in, for example, a format of a bit map image.

In addition, when receiving a request for reading from data retained in the storage region of the storage device 100-1 during the initial synchronization process, the control unit 130-1 included in the storage device 100-1 returns required data. At the data synchronization process, for example, as illustrated in FIG. 8(A) or 8(C), an access state with respect to the storage device 100-2 is “access denied”. Thus, the operation server 300 and other servers do not access the storage device 100-2.

The initial synchronization process is performed until, for example, data stored in the storage region of the storage device 100-1 being a migration source are transferred to a last address. When the initial synchronization process is completed, a differential synchronization process is subsequently performed.

In the differential synchronization process, the control unit 130-1 transfers information stored as the differential information during execution of the initial synchronization process, to the storage region of the storage unit 110-2 being a migration destination. Specifically, the control unit 130-1 transfers information stored as the differential information, for example, sequentially from an initial address of the storage region, via an access path. The control unit 130-2 records the transferred information to the storage region of the storage unit 110-2 being a migration destination.

When receiving a request for writing to data retained in a region where transfer of data is not completed in the storage region of the storage unit 110-1, the control unit 130-1 writes data, which is requested for writing, to the storage region. In addition, the control unit 130-1 writes data, which is requested for writing, to the differential information.

When receiving a request for writing to data retained in a region where transfer of data is completed in the storage region of the storage unit 110-1, the control unit 130-1 writes data, which is requested for writing, to the storage region. Then, the control unit 130-1 transfers the data to the storage device 100-2. When the data are transferred, the control unit 130-2 of the storage device 100-2 writes the data to the storage region of the storage unit 110-2 to be a migration destination. When transfer of all pieces of information included in the differential information is completed, the synchronization process is completed.

Note that, when receiving a request for reading of data retained in the storage region of the storage unit 110-1 during the differential synchronization process, the storage device 100-1 returns required data, similarly as in the differential synchronization process.

Upon confirming completion of the synchronization process, the management control unit 220 of the management device 200 notifies the control units 130-1 and 130-2 of the completion of the synchronization process (Step S109). Upon being notified of the completion of the synchronization process, each of the control units 130-1 and 130-2 changes information relating to a synchronization state of the migration state in each storage management table into “synchronized” (Steps S110 and S111). The processing of Steps S110 and 111 is performed in freely-selected order.

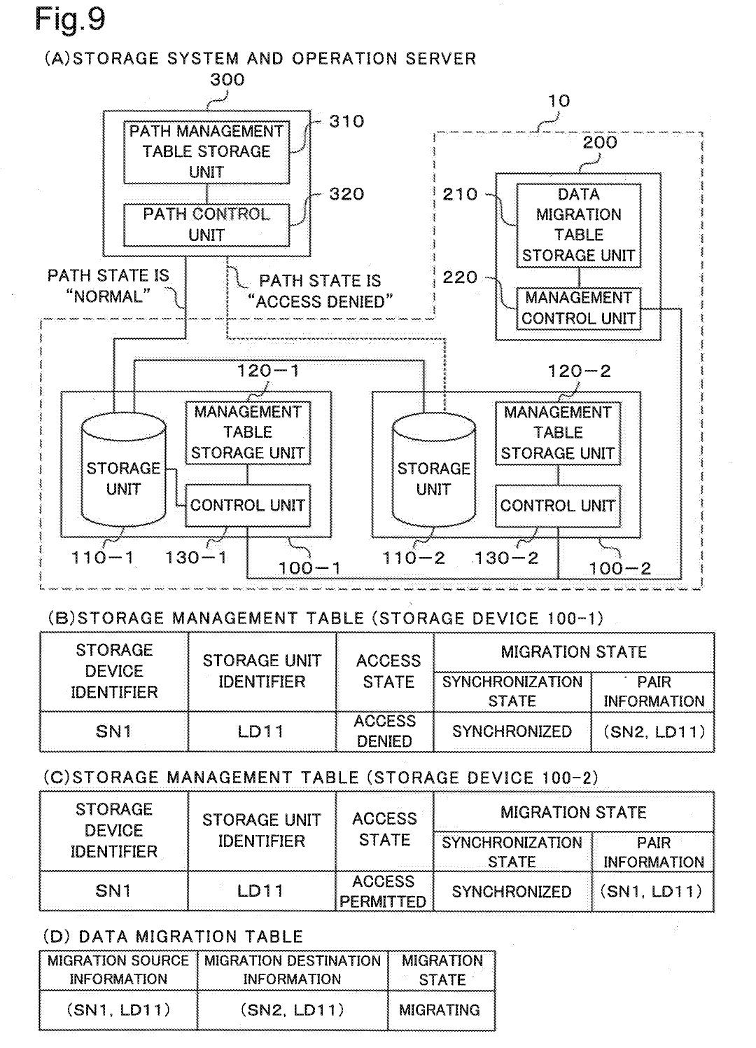

The storage management table stored in each of the management table storage units 120-1 and 120-2 in this case is as illustrated in, for example, FIG. 9(B) or 9(C). In addition, the data migration table stored in the data migration table storage unit 210 is as illustrated in, for example, FIG. 9(D).

Next, as one process of data migration, a separation process of storage devices of a migration source and a migration destination is performed. By the separation process, storage devices of a migration source and a migration destination are separated from each other, and an access destination is changed to the migration-destination storage device.

In this case, the management control unit 220 included in the management device 200 instructs each of the control units 130-1 and 130-2 included respectively in the storage devices 100-1 and 100-2 to execute the separation process (Step S112).

Upon receiving the instruction for executing the separation process, each of the control units 130-1 and 130-2 updates the storage management table (Steps S113 and S114). The processing of Steps S113 and S114 is performed in freely-selected order. Each of the control units 130-1 and 130-2 updates information relating to a migration state in the storage management table.

The control unit 130-1 sets “separation completion waiting” to an access state included in the storage management table. In addition, the control unit 130-1 sets “separating” to information relating to a synchronization state in the migration state included in the storage management table.

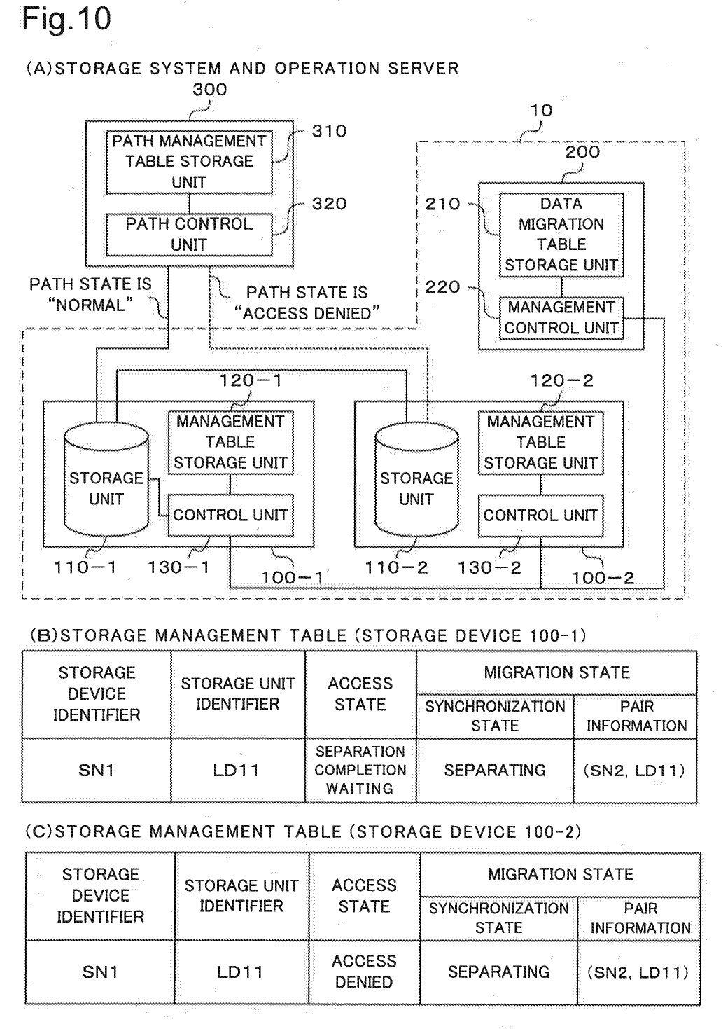

In addition, the control unit 130-2 sets “separating” to information relating to a synchronization state in the migration state included in the storage management table. The updated storage management tables are as illustrated in, for example, FIGS. 10(B) and 10(C), respectively.

Note that, also in this case, the path management table retained in the path management table 310 of the operation server 300 undergoes no change. In other words, as illustrated in FIG. 10(A), a path state from the operation server 300 to the storage device 100-1 is a state “normal”, and a path state from the operation server 300 to the storage device 100-1 is a state “access denied”.

When the separation process completes, the control unit 130-1 included in the storage device 100-1 notifies the management control unit 220 included in the management device 200 of completion of the separation process (Step S115). Upon receiving the notification, the management control unit 220 notifies the control unit 130-2 included in the storage device 100-2 being a migration destination of completion of the separation process (Step S116).

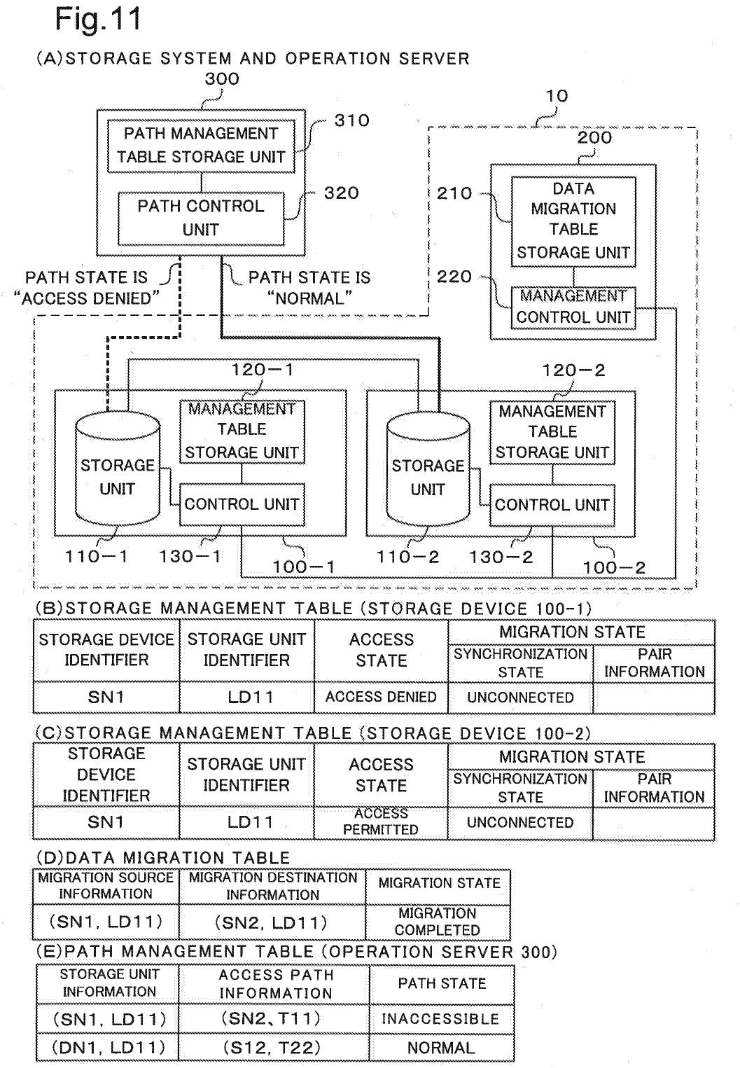

Upon receiving the notification of separation completion, the control unit 130-2 updates the storage management table retained in the management table storage unit 120-2 (Step S117). The control unit 130-2 sets an access state included in the storage management table to “access permitted”. In addition, the control unit 130-2 sets “unconnected” to information relating to a synchronization state in the migration state included in the storage management table, and sets pair information in the migration state blank. The updated storage management table is as illustrated in, for example, FIG. 11(C).

Changing an access state included in the storage management table in this way enables access from outside of the storage system 10, including the operation server 300, to the storage device 100-2.

Next, the management control unit 220 included in the management device 200 instructs the control unit 130-1 of the storage device 100-1 being a migration source to change an access state (Step S118).

Upon receiving the instruction relating to change of an access state, the control unit 130-1 included in the storage device 100-1 updates the storage management table retained in the management table storage unit 120-1 (Step S119). The control unit 130-1 sets an access state included in the storage management table to “access denied”. In addition, the control unit 130-1 sets “unconnected” to information relating to a synchronization state in the migration state included in the storage management table, and leaves pair information included in the migration state blank. The updated storage management table is as illustrated in, for example, FIG. 11(B).

In addition, the control unit 130-1 included in the storage device 100-1 responds to a request for access made by the operation server 300 and other devices when an access state included in the storage management table is “separation completion waiting” (Step S120). In other words, the control unit 130-1 responds to the operation server 300 and the like being an access source that an access state has been changed. In other words, as for access performed with respect to the storage device 100-1 in this case, the control unit 130-1 does not record and read data relevant to the access.

Next, the management control unit 220 included the management device 200 updates the data migration table retained in the data migration table storage unit 210 (Step S121). The management control unit 220 updates an item of the migration state in the data migration table to “migration completed”. The updated data migration table is as in FIG. 11(D), for example.

In response to a notification at preceding Step S120 that an access state has been changed, the path control unit 320 included in the operation server 300 acquires the latest state relating to the path management table stored in the path management table 310. Then, the path control unit 320 updates information relating to the path state in the path management table, based on a state relating to the access state of the storage management table stored in each of the management table storage units 120-1 and 120-2.

In this example, the path control unit 320 sets “inaccessible” to a path state of information with access path information of a pair (S11, T11) (information representing the storage device 100-1). In addition, the path control unit 320 sets “normal” to a path state of information whose access path information is a pair (S12, T22) (information representing the storage device 100-2). The updated path management table is as in FIG. 11(E), for example. In other words, as illustrated in FIG. 11(A), a path state from the operation server 300 to the storage device 100-1 is a state “access denied”, and a path state from the operation server 300 to the storage device 100-1 is a state “normal”.

When the path management table is updated, the operation server 300 again performs access for which the notification that an access state has been changed is previously made, based on the new path management table. In this example, the operation server 300 accesses the storage device 100-2 whose path state of the access path information is “normal”.

When the storage region configured in the storage unit 110-2 of the storage device 100-2 is accessed, the control unit 130-2 confirms completion of data migration (Step S122). Then, the control unit 130-2 notifies the control unit 220 of the management device 200 of the completion of data migration (Step S123).

Upon being notified of the completion of data migration, the control unit 220 instructs the control unit 130-1 included in the storage device 100-1 to execute an offline process as one process of data migration (Step S124).

Upon receiving the instruction for executing the offline process, the control unit 130-1 updates the storage management table retained in the management table storage unit 120-1 (Step S125). The control unit 130-1 sets “offline” to an access state included in the storage management table.

Note that, in the operation server 300, when an access state in the storage management table retained in the management table storage unit 120-1 is changed into “offline”, the path control unit 320 updates information in the path management table as appropriate. In other words, the path control unit 320 removes information whose access path information is a pair (S11, T11) (information representing the storage device 100-1) among information included in the path management table. In other words, the operation server 300 is in a state being only connected with the storage device 100-2 among the storage devices 100-1 and 100-2.

In other words, in the process of data migration, each of the control units 130-1 and 130-2 included in the storage devices 100-1 and 100-2 updates information and the like relating to an access state in the storage management table, in accordance with progress of data migration. In addition, the management control unit 220 included in the management device 220 instructs a procedure of migration as appropriate, in such a way that information relating to an access state in the storage management table included in each of the storage devices 100-1 and 100-2 and the like are updated, in accordance with progress of the data migration process.

Further, in each of the storage devices 100-1 and 100-2, storage regions to be targets of data migration are respectively assigned with the identical storage device identifier and the identical storage unit identifier.

Therefore, the operation server 300 using data stored in the storage system 10 can determine an access destination, based on information relating to an access state in the storage management table of the storage device 100-1 or 100-2, and the like. In data migration performed in the storage system 10, the operation server 300 may become possible to select a storage device to be accessed appropriately in accordance with progress of the data migration, even without periodical monitoring relating to a state of the data migration. In addition, the storage system 10 becomes possible to execute a data migration process without terminating a process executed in the operation server 300.

In addition, the storage system 10 according to the present example embodiment enables the data migration described above, regardless of a type of an interface connecting each of the storage devices 100-1 and 100-2 with the operation server 300.

As described above, when the storage device 100 according to the present example embodiment performs data migration with another storage device 100, the control unit updates information relating to an access state in a storage management table, and the like. In addition, a storage system according to the present example embodiment controls in such a way as to instruct the storage devices 100 of migration-source and migration destination to migrate data and update information relating to an access state in accordance with the data migration.

Since access control to the storage device 100 is performed by the storage device 100, a system using data retained in the storage device 100 is allowed to appropriately select the storage device 100 to be accessed, in accordance with progress of data migration.

Since access to the storage device 100 is controlled by the storage device 100, a system which uses data retained in the storage device 100 is allowed to appropriately select the storage device 100 to be accessed, in accordance with progress of data migration. Accordingly, when data migration is performed in the storage device 100, a system using data retained in the storage device 100 eliminates necessity of periodical monitoring relating to the state.

Therefore, the storage device and the storage system according to the present example embodiment can reduce, in data migration between storages, an impact on a system and the like, which use data stored in the storage device.

While the present invention has been described with reference to the example embodiments thereof, the present invention is not limited to the above-described example embodiments. It will be understood by those skilled in the art that various modification can be made to the configurations and details of the present invention within the scope of the present invention. In addition, the configurations in the respective example embodiments can be combined with one another as far as not departing from the scope of the present invention.

This application is based upon and claims the benefit of priority from Japanese Patent Application No. 2015-57451, filed on Mar. 20, 2015, the disclosure of which is incorporated herein in its entirety.

### REFERENCE SIGNS LIST

10 Storage system

100 Storage device

110 Storage unit

120 Management table storage unit

130 Control unit

200 Management device

210 Data migration table storage unit

220 Management control unit

300 Operation server

310 Path management table storage unit

320 Path control unit

500 Information processing device

501 CPU

502 ROM

503 RAM

504 Program

505 Storage device

506 Recording medium

507 Drive device

508 Communication interface

509 Network

510 Input/output interface

511 Bus

What is claimed is:

1. A storage device comprising:
a first storage configured to retain a storage region which stores data,
a management table retaining identification information relating to the storage region, access state information relating to accessibility to the storage region, and migration information indicating a state relating to migration of data stored in the storage region; and
at least one first processing component configured to:
change the access state information in accordance with a state of data migration with respect to the data stored in the storage region, based on an instruction from a management device managing the data migration.

2. The storage device according to claim 1, wherein the at least one first processing component further configured to change the access state to information indicating a state of suspending both recording of data to or reading of data from the storage region, when transfer of the data stored in the storage region is completed in the data migration.

3. The storage device according to claim 2, wherein the at least one first processing component further configured to respond to a request of recording data to or reading data or from the storage region that the access state is changed, when the access state is information indicating a state of suspending both recording of data to or reading of data from the storage region.

4. The storage device according to claim 1, wherein the at least one first processing component further configured to change the access state to information indicating a state of denying both recording of data to or reading of data from the storage region when the data are transferred to the storage region in the data migration, and, change the access state to information indicating a state of permitting both recording of data to or reading of data from the storage region when transfer of the data to the storage region is completed in the data migration.

5. (canceled)

6. A storage system comprising:
a migration-source storage device to be a source of the data migration, the migration-source storage device being the storage device according to claim 1;
a migration-destination storage device to be a destination of the data migration, the migration-destination device being the storage device according to claim 1; and
a management device configured to manage the data migration from the migration-source storage device to the migration-destination storage device, wherein
the management device includes:
a second storage configured to store a data migration table which retains information relating to the storage region in each of the migration-source storage device and the migration-destination storage device and a state of the data migration; and
at least one second processing component configured to:
control the data migration, and change the access state information retained in each of the migration-source storage device and the migration-destination storage device in accordance with the data migration.

7. The storage system according to claim 6, wherein the at least one second processing component further configured to instruct the at least one first processing component included in the migration-destination storage device to change the access state to information indicating a state of permitting both recording of data to or reading of data from the storage region, and instruct the at least one first processing component included in the migration-source storage device to change the access state to information indicating a state of suspending both recording of data to or reading of data from the storage region, when being notified by the at least one first processing component included in the migration-source storage device that transfer of the data stored in the storage region included in the migration-source storage device is completed in the data migration.

8. The storage system according to claim 6, wherein the at least one second processing component further configured to control in such a way as to set an identical identifier as the identification information relating to the storage region of the migration-source storage device, to the identification information relating to the storage region of the migration-destination storage device.

9. A data migration method comprising:
retaining a management table which retains identification information relating to a storage region, access state information relating to accessibility to the storage region, and migration information indicating a state relating to migration of data stored in the storage region;
migrating data stored in the storage region; and
changing the access state information in accordance with a state of migration of the data.

10. A computer-readable recording medium storing a program causing a computer to execute:
a process of retaining a management table which retains identification information relating to a storage region, access state information relating to accessibility to the storage region, and migration information indicating a state relating to migration of data stored in the storage region;
a process of migrating data stored in the storage region; and
a process of changing the access state information in accordance with a state of the data migration.
